(19) United States
(12) Patent Application Publication
(10) Pub. No.: US 2010/0248831 A1
(43) Pub. Date: Sep. 30, 2010

(54) ACQUIRING IMAGES WITHIN A 3-DIMENSIONAL ROOM

(75) Inventors: Yoeri Geutskens, Nuenen (NL); Richard P. Kleihorst, Kasterlee (BE); Pim Korving, Waalre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/740,723

(22) PCT Filed: Oct. 28, 2008
(86) PCT No.: PCT/IB08/54443

§ 371 Date: May 3, 2010

(30) Foreign Application Priority Data
Nov. 2, 2007 (EP) 07119889.9

(51) Int. Cl. A63F 13/00; G06K 9/00

(52) U.S. Cl. 463/32; 382/154

(57) ABSTRACT

The application relates to acquiring images within a 3-dimensional room 4. Image acquiring areas 6 of the at least two imaging units 2 overlap within the room 4 within at least one 3-dimensional overlap box 8. In order to reduce occlusion, there is provided at least one image processing unit 10 arranged for obtaining the acquired images from the at least two imaging units 2, and for determining information about the at least one 3-dimensional overlap box 8, wherein said image processing unit 10 is further arranged for outputting information about the 3-dimensional overlap box 8 for being output by an information output unit 12.

### FIELD OF THE INVENTION

The present patent application relates to a system arranged for acquiring images within a 3-dimensional room. The application further relates to a method for acquiring images within a 3-dimensional room, a computer program product as well as a computer program for acquiring images within a 3-dimensional room as well as a gaming console being capable of acquiring images within a 3-dimensional room.

### BACKGROUND OF THE INVENTION

In current gaming console applications, for example in a video game, a camera may be used to observe the player (user) or the players (users) within the video game. The players may operate the video game by their motions and gestures acquired from the cameras. Also, in personal computer applications, gestures of entities, for example humans, may be acquired for operating the program. For example from U.S. Pat. No. 6,901,561 B1, there is already known a method and apparatus to recognize actions of a user and to have those actions correspond to specific computer functions. According to this prior art, it is possible to display an image of a user within a window on a screen. A window may include a target area. The method may further include associating a first computer event with a first user action displayed in the target area and storing information in a memory device such that the first user action is associated with a first computer event. The system may recognized specific user actions and may associate the specific user actions with the specific computer comments.

However, multi player video games, as well as more sophisticated camera applications move to the use of multiple cameras. When multiple cameras are used, they may be roughly directed at the same point in a 3-dimensional room from different angles. The viewing angles of the cameras may overlap in the middle and there will be an area of the 3-dimensional room that all cameras can survey (overlapping area; overlap box). This area is the ideal spot for the user to perform any actions.

Applying multiple cameras may prevent the possibility of occlusion of the user. Nevertheless, a user may find it difficult to estimate the volume and precise location of the overlapping area, in particular if the user is unaware of how wide the viewing angle of each of the cameras is.

Therefore, it was an object of the present application to provide for a method, a system, a computer program, and a gaming console capable of using multiple image acquiring units, for example cameras, being easy to handle by users. It was another object of the application to provide for minimizing occlusion, when operating a computer program using more than one camera. Another object of the present patent application is to increase usability of multi-camera systems.

### SUMMARY OF THE INVENTION

These and other objects of the application are solved by a system comprising at least two imaging units arranged for acquiring images within a 3-dimensional room. Within the 3-dimensional room, image acquiring areas of the at least two imaging units may overlap within at least one 3-dimensional overlap box. There may be provided at least one image processing unit arranged for obtaining the acquired images from the at least two imaging units. The image processing units may determine information about the at least one 3-dimensional overlap box. The image processing unit may further be arranged for outputting information about the 3-dimensional overlap box for being output by an information output unit.

Obtaining information about the overlap box may allow the image processing unit to output this information. Outputting this information may allow giving information to a user how to position himself within the overlap box so as to prevent occlusion. Further, the user may be instructed to move into the overlap box in order to provide for operating the computer program or the video game or the video console or events thereon within a 3-dimensional room for example by 3-dimensional gestures.

Determining information about the at least one 3-dimensional overlap box may be provided by calculating the position and the viewing angle of the image obtaining units. The image obtaining units may, for example, be cameras. It may be possible that the cameras mutually detect each others location. It may be possible that the camera position may be pre-defined and stored within the image processing unit. It may also be possible that the cameras mutually detect each others viewing angle and provide this information to the image processing unit. The image processing unit may also know the cameras viewing angles and may calculate from the known position the at least one 3-dimensional overlap box.

Providing the information about the 3-dimensional overlap box within an information output unit may allow the user to estimate a precise location of the overlapping area. In particular, the user does not have to care about the viewing angle of the cameras. Visualizing the space where the camera beams intercept each other may allow the user to move around in the 3-dimensional room being properly visible to all cameras, which is when the user moves around in the overlap box.

According to embodiments, there is provided arranging the image processing unit for outputting information about the areas within the room, where the image acquiring areas of the at least two imaging units do not overlap. By providing information about the overlap box as well as information about the areas where there is no overlap of the camera beams allows for instructing the user precisely to move into the overlap box. In particular it may be possible to indicate to the user that he is outside the overlap box by providing information about the areas, where the image acquiring areas of the at least two imaging units do not overlap.

According to a further embodiment, at least three imaging units may be provided. It may be possible that the image acquiring areas of the at least three imaging units overlap within the room within at least one first 3-dimensional overlap box. The first 3-dimensional overlap box may be the overlap box, where the camera beams of all cameras overlap each other. For example, having three cameras within a room, there is one box, where the viewing angles of the cameras are such that the image acquiring areas, i.e. the camera beams, of all cameras overlap. This first 3-dimensional overlap box provides for the best view onto a user and the best prevention of occlusion. Further, within the embodiment with at least three imaging units, image acquiring areas of two imaging units may overlap within the room within at least one second 3-dimensional overlap box. Within the second 3-dimensional overlap box(es), the beams of exactly two cameras may overlap. This area may be understood as medium quality area, where user gestures may be obtained with a good preciseness, however, with less preciseness than in the first 3-dimensional overlap box.

Further, to the first and the second overlap boxes, within the 3-dimensional rooms there may also be areas, where the acquiring areas of the imaging units do not overlap.

The image processing unit may be arranged for determining information about the first 3-dimensional overlap box, the second 3-dimensional overlap box, and the areas of no overlap. The image processing unit may further be arranged for outputting information about the first 3-dimensional overlap box, the second 3-dimensional overlap box, and the areas of no overlap for being output by the information output unit. By outputting this information, the user may know where he is seen by three cameras, where he is seen by two cameras, and where he is seen by only one camera. This may allow the user to move precisely into the location, where occlusion is prevented best, which may be the first 3-dimensional overlap box.

According to embodiments, the information output unit comprises a display unit arranged for projecting the room within a 3-dimensional display screen and for displaying within the projected room at least one 3-dimensional overlap box. Displaying the overlap box within a screen allows the user to move himself into this area. For example, on the screen the position of the user as well as the position of the overlap box may be displayed and the user may move himself to the location of the overlap box. A projection of the room and the overlap boxes needs not to be limited to view of the room according to the actual angles of the cameras. Instead, the view onto the room and onto the overlap box being displayed on the screen may, for example, be rotated by six or less degrees of freedom, such that the user can aligned the view onto the room with his own viewing angle onto the screen or within the room.

In order to probably display the first and the second overlap boxes and the area of no overlap, it may be possible to arrange the display unit for discriminating at least the first 3-dimensional overlap box and the area of the no overlap box, and the area of no overlap box by providing different optical information within the screen, according to embodiments.

For example, the different areas and overlap boxes may be visualized by different colors, different shading, different textures, different contrast, different brightness, or the like.

According to embodiments, it may be possible to arrange the imaging units for acquiring information of an entity and/or gestures of an entity within a room. It may be possible to obtain an image of the entity. It may also be possible, to obtain only contours of the entity and to obtain the gestures and the position of the entity from its contour.

According to embodiments, the imaging units may be arranged for acquiring the spatial position of the entity. By acquiring the spatial position of the entity, it is possible to put this position into relation to the overlap box, according to embodiments. This may allow for instructing the user, whether he is within the overlap box or not and to instruct the user to move to a certain direction to come into the overlap box.

According to embodiments, the imaging units may be arranged for determining each others location within the room. The imaging units may further be arranged for mutually detecting each others viewing angle. For example, each imaging unit may provide for a lighting unit, for example a LED, which allows for the other imaging unit for spotting the location. The imaging units may further communicate with each other by means of wired or wireless communication and may communicate their viewing angle and/or their position to each other. However, it may also be possible that the image processing unit determines the position and the viewing angle of the imaging unit.

Embodiments provide for calculating at least one 3-dimensional overlap box at least from the location information of the imaging unit within the image processing unit.

According to embodiments, the image processing unit may be arranged for calculating at least one 3-dimensional overlap box at least from information about a viewing angle of the imaging units. The display unit may be arranged for manipulating the display of the at least one 3-dimensional overlap box within the projected 3-dimensional room, according to embodiments.

In order to give users information about their relative position to the overlap box, it may also be possible to put out acoustic information. For example, the information output unit may be arranged for providing acoustical information depending on at least one overlap box and the relative spatial position of the at least one entity. According to embodiments, the information output unit may form a part of a gaming console.

Another aspect of the application is a method comprising acquiring at least two images within a 3-dimensional room, wherein image acquiring areas of at least two imaging units overlap within the room within at least one 3-dimensional overlap box, obtaining the acquired images, determining information about the at least one 3-dimensional overlap box, and outputting information about the 3-dimensional overlap box.

A further aspect of the application is a computer program product comprising instructions which operate a processor to acquire at least two images within a 3-dimensional room. Image acquiring areas of the at least two imaging units may overlap within the room within at least one 3-dimensional overlap box. The acquired images may be obtained. Information about the at least one 3-dimensional overlap box may be determined. The information about the 3-dimensional overlap box may be output.

Another aspect of the application is a computer program comprising instructions, which operate a processor to acquire at least two images within a 3-dimensional room. Image acquiring areas of the at least two imaging units may overlap within the room within at least one 3-dimensional overlap box. The acquired images may be obtained. Information about the at least one 3-dimensional overlap box may be determined. Information about the 3-dimensional overlap box may be output.

A further aspect of the application is a gaming console. The gaming console may comprise at least one image processing unit arranged for obtaining acquired images from at least two imaging units. The image processing unit may further be arranged for determining information about at least one 3-dimensional overlap box. Within a room, image acquiring areas of at least two imaging units overlap. The image processing unit may further be arranged for outputting information about the 3-dimensional overlap box for being output by an information output unit. A processor may be provided for processing information of an entity relative to the overlap box.

These and other aspects of the application will become apparent from and elucidated with reference to the following Figures.

### BRIEF DESCRIPTION OF THE FIGURES

FIG. 1 illustrates a room with two cameras;

FIG. 2 illustrates a top view onto a room with three cameras;

FIG. 3 illustrates a system for obtaining images;

FIG. 4 illustrates a camera for acquiring images.

### DETAILED DESCRIPTION OF THE FIGURES

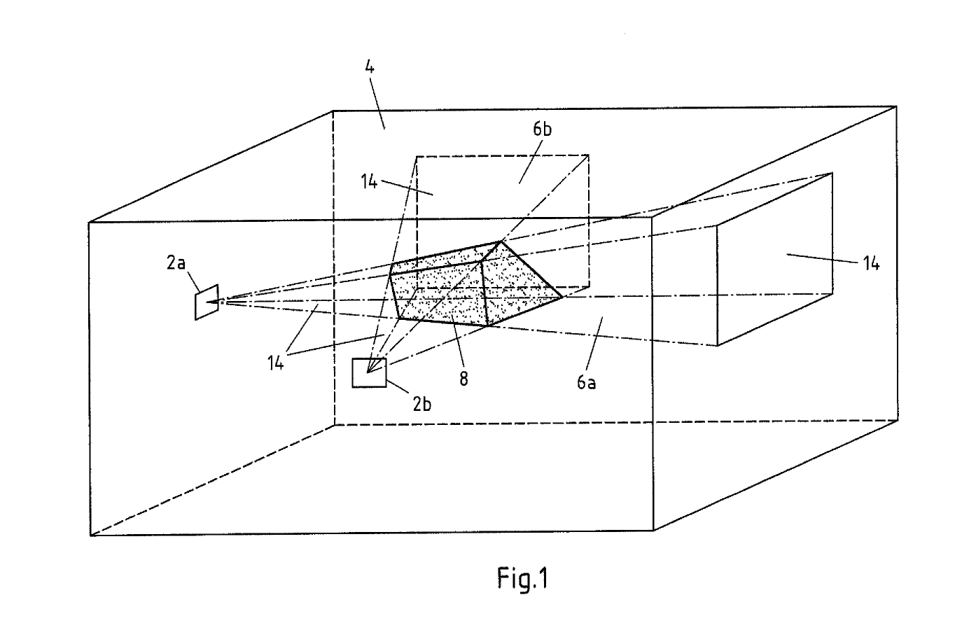

FIG. 1 illustrates schematically a 3-dimensional room 4. Within the 3-dimensional room 4, two imaging units 2a, 2b, which may be cameras, such as CCD-cameras, are arranged. Schematically illustrated are image acquiring areas 6a, 6b. Image acquiring area 6a is the area, from which imaging unit 2 can take images. The size of image acquiring area 6a is defined by the viewing angle of imaging unit 2a. Imaging area 6b is defined by the viewing angle of imaging unit 2b. The imaging areas 6a, 6b intersect within overlap box 8 illustrated as a dotted-area. The overlap of the image acquiring areas 6a, 6b is the overlap box 8, within which both imaging units 2a, 2b acquire images within room 4.

Further illustrated are areas 14, within which the image acquiring areas 6a, 6b do not overlap and within which only one imaging unit 2a, 2b obtains an image.

For example, when the view onto overlap box 8 is abstracted for imaging unit 2b, for example, when an object is placed in front of overlap box 8, still imaging unit 2a may obtain an image of an entity within overlap box 8. Thus, within overlap box 8, occlusion may be minimized or prevented.

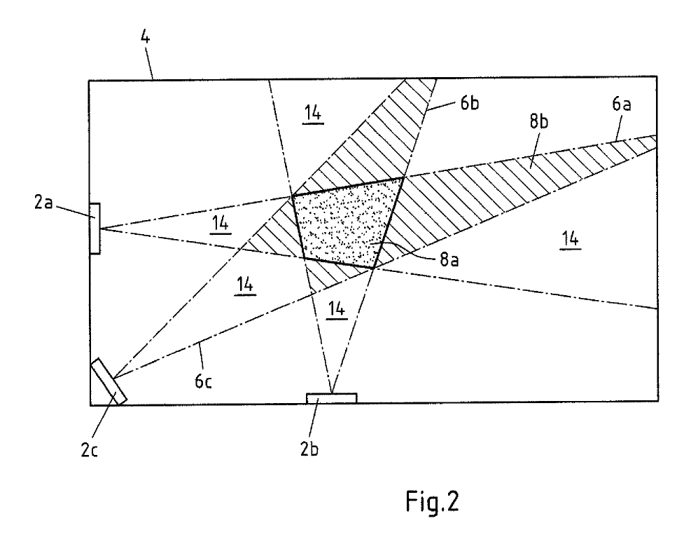

FIG. 2 illustrates a top view onto a room 4, where besides imaging units 2a, 2b, further imaging unit 2c is provided. As can be seen, image acquiring areas 6a, 6b, and 6c, which is the image acquiring area 6c of imaging unit 2c, overlap in the middle of the room 4 within a first overlap box 8a. Within this first overlap box 8a, all three imaging units 2a-c can acquire an image. Besides overlap box 8a, there are overlap boxes 8b, illustrated with lines, within which two imaging units 2a, 2b, 2c, respectively, can obtain images. This may be understood as second overlap box 8b. Besides the overlap boxes 8, there are areas 14, within which only one imaging unit 2 can obtain an image.

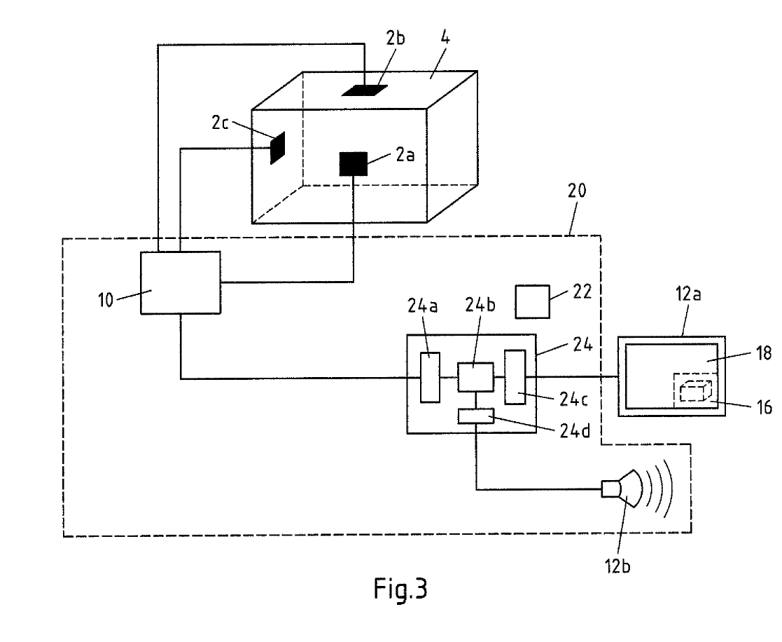

FIG. 3 illustrates a system with a room 4, as illustrated in FIGS. 1, 2 having imaging units 2. Further illustrated is an image processing unit 10, a processor 24, a gaming console 20, output units 12a, 12b, and a computer program product 22. Further, output unit 12a comprises a screen 18, and output unit 12b comprises a loudspeaker.

Image processing unit 10 may obtain from imaging units 2 acquired images within room 4. Further, imaging units 2 may communicate with each other and communicate their viewing angle and their position within room 4. The information above position and viewing angle of imaging units 2 may further be communicated to image processing unit 10.

By having the information about the viewing angle and the position of imaging units 2, image processing unit 10 may process and calculate information about a first overlap box 8a, the second overlap box 8b, and the areas 14, as illustrated in FIG. 2.

Having calculated this information, image processing unit 10 may provide this information to processor 24. Within processor 24, an interface 24a, may receive the information about the acquired images from imaging unit 2, as well as the information about the overlap boxes 8, and the areas 14. The information about the overlap boxes 8 and areas 14, as well as the image information from the imaging units 2 are processed in controller 24b.

The image information is provided to interface 24c.

Besides the image information from imaging unit 2, the information about the overlap boxes 8 and the areas 14 are provided to interface 24c. Interface 24c provides the information to output unit 12a. Depending on the provided information, within screen 18, there is an area, where the room 4 is projected as projected room 16. Within projected room 16, room 4 is graphically illustrated. Besides illustrating room 4, at least one overlap box 8 within room 4 is illustrated in projected room 16. Further, the position of the cameras may be illustrated in projected room 16. In addition, the viewing angles and the image acquiring areas 6 of imaging unit 2 may be illustrated in projected room 16. In addition, areas 14 may be illustrated in projected room 16. The projected room 16 may be moved, tilted, rolled, panned and the like by six degrees of freedom with screen 18, so as to allow adjusting the view onto projected room 16 aligned with a position of an entity with room 4. Within projected room 16 it is possible to display also an entity being within room 4. By displaying the entity as well as the overlap boxes 8 within projected room 16, the entity in room 4 is allowed to position itself within the overlap box 8. Thus, the entity can assure that it is seen by at least two or even more imaging units 2.

Besides graphically outputting overlap boxes 18, and areas 14, interface 24d may output the information about overlap box 8 and areas 14 to loudspeaker 12b. Further, the information about the entity may be processed to loudspeaker 12b. It may also be possible that interface 24d calculates the relative position between an entity within room 4 and the overlap box 8. In case the entity is outside overlap box 8, interface 24d may instruct loudspeaker 12b to put out information to the entity to move into the box. This may be up-down, right-left information, as well as different sounds or other instructions, which are capable to instruct an entity to move within overlap box 8.

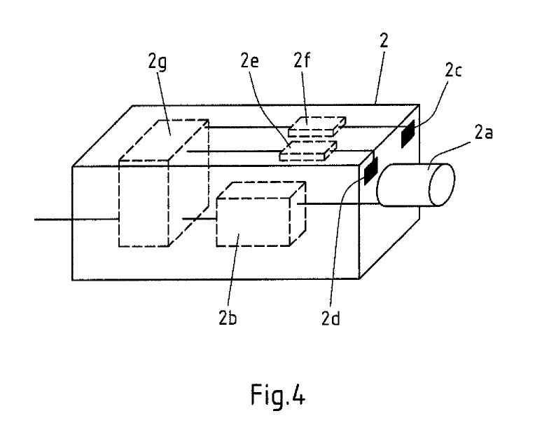

FIG. 4 illustrates an imaging unit 2. Imaging unit 2 may comprise an objective 2a, and an image sensor 2b for obtaining the images acquired by objective 2a. Further, imaging unit 2 may comprise an LED 2c, and a light sensor 2d. Processor 2f may instruct LED 2c to blink. Processor 2e may obtain information from a sensor 2d about the relative position of blinking LEDs of other imaging units 2 and thus allows obtaining information about the position of other cameras. By instructing LED 2c to blink, other cameras may obtain the position of the illustrated imaging unit 2. A further processor 2g may process, besides the image information 2b, the information about the position obtained by sensor 2e. Further, the image information and the position information, as well as viewing angle information may be output from imaging unit 2 by processor 2g.

By providing the information about the overlap box, the application allows for reducing occlusion and instructing entities to move into overlap boxes easily. This may improve operability of camera controlled video consoles.

1. A system comprising:
at least two imaging units arranged for acquiring images within a 3-dimensional room,
wherein image acquiring areas of the at least two imaging units overlap within the room within at least one 3-dimensional overlap box,
at least one image processing unit arranged for obtaining the acquired images from the at least two imaging units, and for determining information about the at least one 3-dimensional overlap box,
wherein said image processing unit is further arranged for outputting information about the 3-dimensional overlap box for being output by an information output unit.

2. The system of claim 1, wherein said image processing unit is further arranged for outputting information about areas within the room where the image acquiring areas of the at least two imaging units do not overlap.

3. The system of claim 1, wherein at least three imaging units are provided,
wherein image acquiring areas of at least three imaging units overlap within the room within at least one first 3-dimensional overlap box,
wherein image acquiring areas of two imaging units overlap within the room within at least one second 3-dimensional overlap box, and
wherein acquiring areas of the imaging units do not overlap,
wherein the image processing unit is arranged for determining information about the first 3-dimensional overlap box, the second 3-dimensional overlap box, and the areas of no overlap, and
wherein the image processing unit is further arranged for outputting information about the first 3-dimensional overlap box, the second 3-dimensional overlap box and the areas of no overlap for being output by the information output unit.

4. The system of claim 1, wherein the information output unit comprises a display unit arranged for projecting the room within a 2-dimensional display screen and for displaying within the projected room at least one 3-dimensional overlap box.

5. The system of claim 4, wherein the display unit is arranged for discriminating at least the first 3-dimensional overlap box and the area of no overlap by providing different optical information within the screen.

6. The system claim 1, wherein the imaging units are arranged for acquiring information of an entity and/or gestures of an entity within the room.

7. The system of claim 6, wherein the imaging units are arranged for acquiring the spatial position of the entity.

8. The system of claim 6, wherein the information output unit is arranged for outputting information of the entity in relation to at least one overlap box.

9. The system of claim 1, wherein the imaging units are arranged for obtaining each others location within the room.

10. The system of claim 9, wherein the image processing unit is arranged for calculating at least one 3-dimensional overlap box at least from the location information of the imaging units.

11. The system of claim 1, wherein the image processing unit is arranged for calculating at least one 3-dimensional overlap box at least from information about a viewing angle of the imaging units.

12. The system of claim 4, wherein the display unit is arranged for manipulating the display of the at least one 3-dimensional overlap box within the projected 3-dimensional room.

13. The system of claim 6, wherein the information output unit is arranged for providing acoustical information depending on at least one overlap box and the relative spatial position of the at least one entity.

14. The system of claim 1, wherein the image processing unit and the information output unit form part of a gaming console.

15. A method comprising:
acquiring at least two images within a 3-dimensional room,
wherein image acquiring areas of at least two imaging units overlap within the room within at least one 3-dimensional overlap box,
obtaining the acquired images,
determining information about the at least one 3-dimensional overlap box, and
outputting information about the 3-dimensional overlap box.

16. A computer program product comprising instruction which operate a processor to
acquire at least two images within a 3-dimensional room,
wherein image acquiring areas of the at least two imaging units overlap within the room within at least one 3-dimensional overlap box,
obtain the acquired images,
determine information about the at least one 3-dimensional overlap box, and
output information about the 3-dimensional overlap box.

17. A computer program comprising instruction which operate a processor to
acquire at least two images within a 3-dimensional room,
wherein image acquiring areas of the at least two imaging units overlap within the room within at least one 3-dimensional overlap box,
obtain the acquired images,
determine information about the at least one 3-dimensional overlap box, and
output information about the 3-dimensional overlap box.

18. A gaming console comprising:
at least one image processing unit arranged for obtaining acquired images from at least two imaging units, and for determining information about at least one 3-dimensional overlap box where image acquiring areas of at least two imaging units overlap within a room,
wherein said image processing unit is further arranged for outputting information about the 3-dimensional overlap box for being output by an information output unit, and
a processor for processing information of an entity relative to the overlap box.
